(19) United States
(12) Patent Application Publication
(10) Pub. No.: US 2026/0050786 A1
(43) Pub. Date: Feb. 19, 2026

(54) MODIFYING A MACHINE LEARNING MODEL TO OBFUSCATE CHARACTERISTICS OF THE MACHINE LEARNING MODEL

(71) Applicant: Google LLC, Mountain View, CA (US)

(72) Inventors: Nahid Farhady Ghalaty, San Diego, CA (US); Matthew Royce Markwell, San Diego, CA (US)

(21) Appl. No.: 19/101,307

(22) PCT Filed: Aug. 5, 2022
(86) PCT No.: PCT/US2022/039632

§ 371 Date: Feb. 5, 2025

(51) Int. Cl. G06N 3/082; G06N 3/04

(52) U.S. Cl. CPC G06N 3/082; G06N 3/04

(57) ABSTRACT

Methods, systems, and apparatus, including computer programs encoded on computer storage media, for obfuscating operations of a neural network. One of the methods includes receiving data representing a neural network. The neural network comprises parameters specifying a sequence of network layers and multiple nodes in each layer of the sequence of network layers. The neural network is compiled to generate instructions that, when executed, causes one or more computation units of a hardware device to perform obfuscating operations associated with inference operations of the neural network. The obfuscating operations, when performed, obfuscate one or more measurable characteristics of the neural network. The compiling comprises determining a target layer of the sequence of network layers; determining obfuscating network structures for association with the target layer; and compiling the neural network with the associated obfuscating network structures to generate instructions for performing the obfuscating operations specified by the obfuscating network structures.

### TECHNICAL FIELD

This specification generally relates to machine learning. In particular, this specification describes techniques for modifying machine learning models to include structures that obfuscate inference operations of the machine learning models when the machine learning models are executed.

### BACKGROUND

Artificial intelligence (AI) is intelligence demonstrated by machines and represents the ability of a computer program or a machine to think and learn. One or more computers can be used to perform computations to train machine learning models for respective tasks. Neural networks belong to a sub-field of machine-learning models.

Neural networks can employ one or more layers of nodes representing multiple operations, e.g., vector or matrix operations. One or more computers can be configured to perform the operations or computations of the neural networks to generate an output, e.g., a classification, a prediction, or a segmentation for a received input. Some neural networks include one or more hidden layers in addition to an output layer. The output of each hidden layer is used as input to the next layer in the network, i.e., the next hidden layer or the output layer. Each layer of the network generates an output from a received input in accordance with the current values of a respective set of network parameters.

Hardware accelerators that are particularly designed can perform specific functions and operations, including operations or computations specified in a neural network, faster and more efficiently when compared to operations run by general-purpose central processing units (CPUs). The hardware accelerators can include graphic processing units (GPUs), tensor processing units (TPUs), video processing units (VPUs), field programmable gate arrays (FPGAs), or application-specific integrated circuits (ASICs).

### SUMMARY

A machine learning model (e.g., a neural network), after being properly trained, can be compiled and deployed on a hardware device configured to perform inference operations for processing input data. The inference operations are defined by parameters of the neural network that are updated during the training process. The parameters define (i) nodal operations (e.g., linear and nonlinear operations) for nodes in each network layer of a neural network and (ii) the structure of the neural network. For example, the parameters defining the nodal operations include parameters defining activation functions for each network layer and parameters defining nodal weights for nodes in a network layer. As another example, the parameters defining the structure (also referred to as hyperparameters) include at least one of the number of nodes in a network layer, the number of network layers in a machine learning model (e.g., in a neural network), or the nodal connections across neighboring layers (e.g., fully connected layers, convolution layers, or transposed convolution layers). For simplicity, the following specification is described for a neural network but can apply to other types of machine learning models.

Keeping parameters of a trained neural network confidential is critical. First of all, training a neural network, in particular, a deep neural network with satisfactory accuracy for generating predictions requires considerable computation cost and time. In addition, some neural networks have applications related to security-sensitive authentication, such as face unlock tasks where a neural network is configured to recognize faces for conveniently unlocking devices. It is therefore critical to maintain the structure and parameters of the neural network undecipherable or at least difficult to decipher to avoid malicious actors learning the parameters and using those parameters for unauthorized device unlocks.

However, different techniques can be applied to “decode” a trained neural network, particularly when the neural network is implemented on a hardware device that is accessible by a third party (e.g., an edge device such as a smartphone, a smartwatch, a smart tablet, or other edge devices). For example, one technique can measure characteristics of a trained neural network when a hardware device performs inference operations of the trained neural network. More specifically, the technique can collect data, e.g., power consumption, electromagnetic waves, or time, when a hardware device performs inference operations, and determine neural network parameters and structure by analyzing characteristic profiles generated based on the collected data. This technique is also referred to as side channel attacks.

The techniques described in this specification can enhance the security for neural networks implemented on hardware devices, e.g., on edge hardware devices. For example, the described techniques defend against side channel attacks by, during compiling time, determining one or more obfuscating network structures associated with one or more original network layers in a neural network, and generating instructions that, when executed by a hardware device, cause the hardware device to perform obfuscating operations specified by the obfuscating network structures, concurrently and/or sequentially, with inference operations of the one or more original network layers.

The one or more original network layers generally refer to “target layers” of a neural network. In some situations, a system can determine one or more critical layers of a neural network as target layers for obfuscating operations of the target layers. Target layers (e.g., critical layers) typically require considerable time and costs to train (e.g., computation resource costs). Alternatively or additionally, target layers (e.g., critical layers) can generally include network layers that are substantially important to a network, e.g., a layer that is critical to improve the performance of the neural network. The performance can include hardware resource requirement, time requirement, power requirement, or other requirements for performing inference operations of the neural network for different tasks. A system (or a compiler) performing the described techniques can determine a target layer by determining whether a network layer is a critical layer based on one or more characteristics associated with the neural network. Example characteristics can include a layer type, a layer size, input and/or output of the layer, or other suitable characteristics. In some implementations, the system can determine that a layer is a critical layer if once one or more criteria are satisfied by the layer, e.g., a threshold memory bandwidth, a threshold power consumption, or other criteria. In this way, the described techniques can prevent side channel attacks or at least raise the bar of the computation costs and/or time cost for deciphering the deployed neural network using side channel attacks. Although these techniques are described largely in terms of target layers (e.g., critical layers), obfuscating layers can be added at or near other non-critical layers. Furthermore, the term “critical layer” is used in the following specification for simplicity, and it should be noted that “critical layers” can be equivalent, or determined or selected as target layers, where operations in the target layers are obfuscated by introducing obfuscating operations performed on hardware devices.

The term “obfuscating operations” as used throughout the specification generally refer to operations that, when performed with machine learning operations (e.g., inference operations) of a deployed neural network by a hardware device, cause a change in one or more measurable characteristics of the neural network, so that at least one parameter of a neural network, e.g., at least one of a number of network layers of the neural network, a number of nodes in a network layer, a nodal operation for a node in a network layer, or a weight associated with a node in a network layer, is obscured. Note that different types of machine learning models include different types of parameters that define the models. The techniques described in this document can obfuscate any type of parameter that impacts the measurable characteristics of the machine learning model.

The one or more measurable characteristics of the neural network generally refer to measurable data when the hardware device performs inference operations in the neural network. The measurable data can include data or a profile related to the power consumption, time, electromagnetic emanations, or other measurable data, as described above.

Note also the obfuscating operations can be performed sequentially and/or concurrently with machine learning operations, depending on the determined obfuscating network structures. The term “concurrently” as used throughout this specification generally refers to a common time period when both obfuscating operations and inference operations are performed by a hardware device. For example, the common time period can be an exactly same time period, a substantially the same time period (e.g., within a threshold period of time of each other), or two different time periods having an overlapping region. The term “sequentially” as used throughout this specification generally refers to the obfuscating operations and the inference operations being performed according to a sequence in different time periods. For example, obfuscating operations can be performed before or after one or more inference operations are performed. The different time periods generally refer to time periods having no overlapping regions.

In situations where the obfuscating operations are concurrently performed with inference operations, the obfuscating network structures can, for example, include one or more obfuscating nodes to be added into one or more critical layers. Obfuscating operations specified by the obfuscating nodes in a critical layer can be performed concurrently with inference operations of original nodes in the critical layer. As another example, obfuscating network structures can be additionally included in instructions when the neural network is compiled. However, these obfuscating network structures do not change the original structure or parameters of the neural network. Rather, obfuscating operations specified by these obfuscating network structures are to be performed concurrently by a hardware device with the inference operations in one or more critical layers. The obfuscating network structures can mimic operations performed by critical layers with similar data flow and/or data operations.

In situations where the obfuscating operations are sequentially performed with inference operations, the obfuscating network structures can, for example, include one or more obfuscating network layers to be added immediately before or after a critical layer. Even though the outputs from obfuscating network layers are not used for downstream operations specified in succeeding original layers, the compiler determines a sequence for performing obfuscation operations in the obfuscating layers and inference operations in original layers as if a succeeding layer awaits an output from a preceding obfuscating layer. In this way, it prevents or at least raises the “cost” bar for distinguishing critical layers and obfuscating network layers using side channel attacks.

Examples of obfuscating operations can include suitable types of linear or nonlinear operations. In situations where the obfuscating operations are performed concurrently with particular inference operations of critical layers, these obfuscating operations can sometimes mimic the actual inference operations. For example, obfuscating operations performed concurrently with a nodal linear operation of a particular node can also be linear operations such as additions, multiplication, and binary operation. As another example, an obfuscating operation performed concurrently with a nodal non-linear operation of a particular node can also be nonlinear operations such as activation functions, e.g., ReLU, Sigmoid, Tanh, or other suitable nonlinear operations. As another example, obfuscating operations can include tensor reduction operations that mimic action-weight multiplications of a network layer. In situations where the obfuscating operations are performed sequentially with inference operations of critical layers, the obfuscating operations can be any suitable nodal or inter-layer operations, for example, linear matrix operations, nonlinear nodal activations, pooling, or other suitable operations. These operations can be independent from the inference operations performed by associated critical layers. Additional examples of obfuscating operations are described below.

In general, a host or a compiler included in the host can compile a machine learning model (e.g., a neural network), and generate instructions that, when executed by a hardware device, cause the hardware device to perform at least inference operations of the neural network. Compilation of a neural network generally refers to converting program codes in a high level programming language (e.g., C++, Python, JAVA, or other programming languages) that represent a neural network into machine-readable low level programming languages (e.g., binary codes). The compiled neural network can be deployed on one or more hardware devices for performing operations according to corresponding instructions. During the compilation step, the described techniques can determine obfuscating network structures to be associated with one or more critical layers of the neural network and generate instructions that, when executed by a hardware device, causes the hardware device to perform concurrently and/or sequentially (i) inference operations of original inference operations of the neural network and (ii) obfuscating operations specified by the obfuscating network structures.

A hardware device can include one or more processing elements configured to process respectively assigned operations according to the instructions. Each of the processing elements can further include multiple computation units specially arranged to perform assigned operations. The assigned operations can include (i) machine learning computations, e.g., in ways that accelerate the performance of the machine learning operations, and/or (ii) obfuscating operations specified by associated obfuscating network structures. Note that the described techniques are compatible and independent from any types of hardware devices suitable for performing machine learning operations (e.g., different types of accelerators such as GPUs, TPUs, VPUs, FPGAs, or ASICs). This is because the described techniques are performed during the compilation step, and the instructions for obfuscating parameters of a machine learning model can be determined differently according to different hardware devices.

The described techniques can determine one or more characteristics of a neural network before compiling, and based on the one or more characteristics, determine whether to associate obfuscating network structures with the neural network, and if so, determine where and how to associate the obfuscating network structures with the neural network. More specifically, the described techniques determine whether to compile a neural network for execution in a “standard mode” (where no obfuscating operations are added to the instructions) or a “secured mode” (where obfuscating operations are added). Compiling a neural network so that the neural network is performed in the secured mode can be referred to as performing the compilation in a secured mode. Similarly, compiling a neural network so that the neural network is performed in the standard mode can be referred to as performing the compilation in a standard mode.

Generally, the system can determine to perform the compilation in a way that prepares the neural network to be run in the secured mode if the neural network is related to security-sensitive tasks, e.g., face authentication tasks. Alternatively, the system can determine to perform the compilation in the secured mode if the neural network requires considerable time and costs for training. In some implementations, the system can determine characteristics of a neural network by metadata associated with the neural network, or by data included in a request from one or more applications that would utilize the neural network. In some implementations, the system can determine whether to compile a neural network in a secured mode based on user input. For example, the developer of the neural network can specify that the neural network should be compiled and run in the secured mode.

After determining to compile a neural network in the secured mode, the described techniques can determine one or more critical layers in a sequence of network layers in the neural network, and determine obfuscating network structures to be associated with the one or more critical layers. A critical layer can be a network layer that requires considerable time and costs (e.g., computation costs) for training. Alternatively, a critical layer can be a layer having operations that considerably affects the performance of the neural network, for example, a particular type of network layer in a sequence of the neural network, a particular inter-layer connection between a layer and the neighboring layers, or a layer with specially-designed nodal operations.

The obfuscating network structures can include obfuscating nodes to be included in an original critical layer, an obfuscating layer to be added immediately before or after a critical layer, and/or nodal or layer operations detached from the neural network but performed concurrently with inference operations of critical layers. These obfuscating nodes and layers and corresponding obfuscating operations, when performed, do not affect the original inference operations of the neural network, e.g., because the output of these obfuscating operations are not used by the original inference operations.

The subject matter described in this specification can be implemented in particular embodiments so as to realize one or more of the following advantages. Compiling a neural network in a secured mode to obfuscate parameters of a deployed neural network in the hardware device can prevent the neural network from being deciphered. More specifically, the obfuscating operations can cause a change in one or more measurable characteristics of a neural network executed by the hardware device, so that it becomes difficult and costs more time and resources to decipher corresponding neural network parameters based on measurable characteristics. Thus, the described techniques enhance data security by preventing the leakage of potentially sensitive machine learning data.

The subject matter described in this specification is further advantageous from the model compilation perspective. For example, the described techniques are general and independent of hardware devices selected for deploying a compiled neural network. Instructions specifying inference operations and obfuscating operations are generated during the compile time for a hardware device, and these operations are scheduled and assigned to different computation units and/or processing elements before the instructions are transmitted to the hardware device. Therefore, the described techniques do not require a specially designed hardware device, which enables a neural network to be deployed on different types of hardware devices.

In addition, the described techniques do not require modifications to a neural network before compilation, therefore, users or technicians do not need to modify the structure of a neural network in a high level programming language to add obfuscating structures/operations. The obfuscated network structures and corresponding obfuscating operations are determined and compiled automatically at compile time. In this way, the described techniques save considerable research and development time for updating a neural network (e.g., determining obfuscating operations before compiling the neural network). This also prevents errors in a neural network that may be introduced in the development to include associated obfuscating operations.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by data processing apparatus, cause the apparatus to perform the actions.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example system including an example secure machine learning model compiler.

FIG. 2 illustrates an example secure machine learning model compiler.

FIG. 3 illustrates an example process of obfuscating network structures associated with an input neural network.

FIG. 4 illustrates another example process of obfuscating network structures associated with an input neural network.

FIG. 5 illustrates another example process of obfuscating network structures associated with an input neural network.

FIG. 6 is an example flow chart of the process for compiling an input neural network with obfuscating network structures.

Like reference numbers and designations in the various drawings indicate like elements.

### DETAILED DESCRIPTION

The subject matter described in this specification relates to modifying machine learning models such that, when the machine learning models are executed, obfuscating operations that obfuscate measurable characteristics of the machine learning model are performed. More specifically, the described techniques are related to determining obfuscating network structures associated with one or more particular layers of an input neural network (also referred to as an original neural network) before compiling a machine learning model, compiling the original neural network with the determined obfuscating network structures, and sending data including the compiled neural network with obfuscating network structures to one or more hardware devices for performing the operations of the neural network. The obfuscating network structures represent multiple obfuscating operations that, when executed by corresponding hardware devices, can obfuscate one or more parameters of the original neural network. The obfuscating operations generally prevent, or at least increase the cost and/or the time for, malicious entities to decipher the network parameters based on observed characteristics profiles associated with the original neural network. The obfuscating network structures to be added to a machine learning model can sometimes be pre-determined or pre-set by users or received as input to the system.

The term “hardware device” as used throughout the specification generally refers to a hardware processor, e.g., a hardware accelerator, deployed on an edge device, e.g., a smartphone, smart tablets, smart watches, or other suitable edge devices. The hardware device can include one or more processing elements, and each processing element can include one or more computation units. The hardware device can perform operations on different processing elements and/or different portions of computation units of each processing element scheduled by instructions received from a host. Each computing unit of the hardware computing system is self-contained and can independently execute at least a portion of computations required by a given layer of a multi-layer neural network or at least a portion of obfuscating operations specified by an obfuscating network structure.

One example machine learning model can be a neural network, which is trained to perform inference tasks. A trained neural network includes multiple parameters defining the neural network and inference operations in the neural network. The parameters of a neural network can include a number of network layers in the neural network, a number of nodes in the neural network, a nodal operation for each node, and/or a nodal weight of each node. The neural network computes an inference for processing an input by performing inference operations of a neural network. In particular, the layers of the neural network each have multiple nodes with respective nodal operations and weights. The nodal operations can include linear operations (e.g., multiplications and additions) or non-linear operations (e.g., activation operations including the ReLu activation function, the Tanh function, and the Sigmoid function). In some implementations, the parameters further include data determining nodal connections between neighboring network layers, e.g., fully connected layers, convolution layers, or transpose convolution layers.

The hardware device can perform inference computation of a neural network and/or obfuscating operations of obfuscating network structures associated with the neural network based on instructions received from the host. A compiler on the host can schedule, when compiling the neural network in the “secured mode,” how these operations are distributed or assigned to what portions of computation units of the hardware device. In some implementations, one or more hardware components in an edge device can include a dynamic scheduling mechanism such that the operations can be scheduled for computation units at runtime.

One example of computation units is tiles each having a computation unit or a processing engine, and/or one more caches and switches. An example computation process performed for a neural network layer can include a multiplication of an input tensor including input activations with a parameter tensor including weights. This computation includes multiplying an input activation with a weight on one or more cycles and performing an accumulation of a product over many cycles. The computation results for the network layer can be written to an output bus and stored in memory. Similarly, obfuscating operations can mimic the above-noted inference computations. However, the results from obfuscating operations are generally not used by the inference computations. In some implementations, the results from obfuscating operations are discarded or stored in memory without being ever fetched for downstream operations.

When performing inference operations of a deployed neural network, a hardware device generates one or more measurable characteristics of the neural network. Different techniques such as side channel attacks can be used to reverse engineer parameters of the trained neural network. In some situations where the hardware device is included in an edge device such as a smartphone, a smart watch, a smart tablet, or other suitable edge devices, one can repeatedly perform test operations using the hardware device and determine parameters of the neural network.

It is desired to maintain neural network parameters confidential for different reasons. One example is from the security point of view. A neural network can be configured to perform human face recognition tasks for conveniently unlocking devices. It would be unsafe to use the face unlocking mechanism if a third party successfully reverse-engineered the neural network and figured out a way to deceive the face unlocking mechanism. For example, a malicious actor might use adversarial attacks to deceive the neural network to unlock devices for which the actor does not have authorization.

The described techniques can solve the above noted security concern by obfuscating inference operations of a neural network. More specifically, the described techniques can issue instructions that, when compiling a neural network in a secured mode, include obfuscating operations represented by obfuscating network structures associated with the neural network. These instructions, when executed on a hardware device, can cause a hardware device to perform both inference operations of the neural network and obfuscating operations to disguise original parameters of the neural network. These obfuscating operations can be performed concurrently and/or sequentially with inference operations, depending on the type of obfuscating network structures associated with the neural network. In this way, the hardware device can change at least one of multiple measurable characteristics of the neural network to efficiently hide or mask the measurable characteristics of the actual machine learning operations being performed by the hardware device, and make the deciphering process impossible, impractical, or at last much more difficult by analyzing the masked or changed measurable characteristics. The details of performing obfuscating operations are described below.

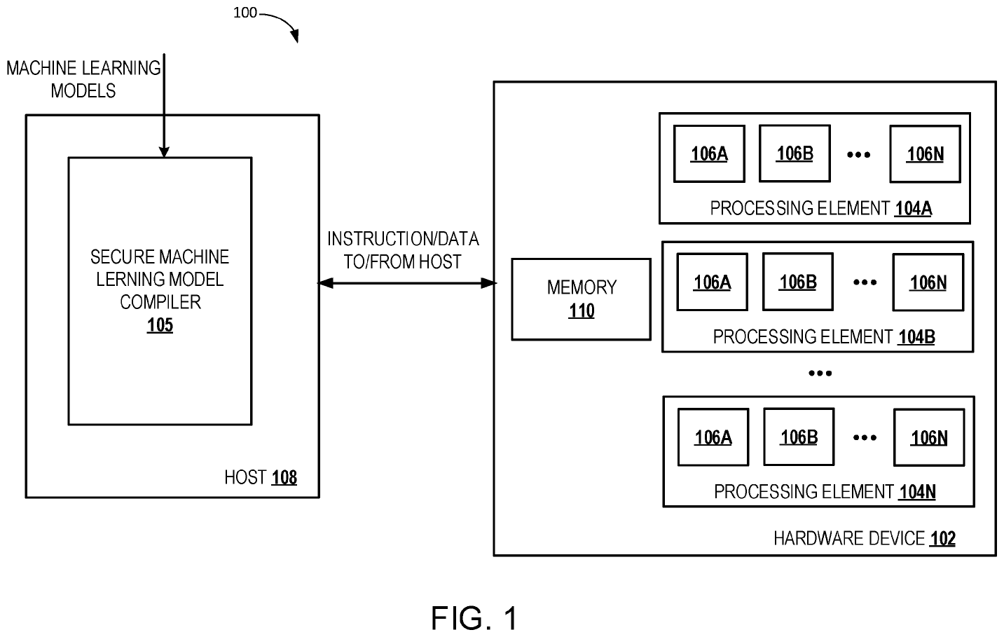

FIG. 1 is a block diagram of an example system 100 including an example secure machine learning model compiler 105. As shown in FIG. 1, the system 100 includes a host 108 and a hardware device 102 communicatively coupled with the host 108, e.g., via one or more networks. In general, the host 108 can be communicatively coupled with more than one hardware device, but for simplicity, only one hardware device 102 is illustrated in FIG. 1.

The host 108 is configured to receive machine learning models, compile the received machine learning models using a secure machine learning model compiler 105, transmit instructions or data including the compiled machine learning models to the hardware device 102, and receive data output from the hardware device 102. The secure machine learning model compiler 105 is configured to compile one or more trained machine learning models (e.g., neural networks) from high level programming languages (e.g., C++, Python, Java) to machine-readable programs (e.g., binary codes). The binary code for a machine learning model generally includes at least all parameters that define the trained machine learning model. The binary code, for example, specifies a number of network layers in the compiled neural network, a type of each network layer, a number of nodes in each network layer, a nodal operation for each node in each network layer, a nodal weight determined for each node in each network layer, and inter-layer connectivity. The binary code can include any other parameters of a machine learning model.

The host 108 also generates instructions that, when executed by the hardware device 102, cause the hardware device 102 to perform inference operations specified by the binary code. In some situations, the compiler 105 determines to include obfuscating operations in the binary code that, when executed by the hardware device 102, cause one or more computation units or processing elements of the hardware device 102 to perform the obfuscating operations. In general, the obfuscating operations are operations that are capable of hiding or masking measurable characteristics of a neural network. In other words, the obfuscating operations can include operations that cause the hardware device 102 and/or the edge device that includes the hardware device 102 to generate or adjust one or more measurable characteristics. The obfuscating operations can include any appropriate machine learning operations/or other operations that generate or adjust the measurable characteristics.

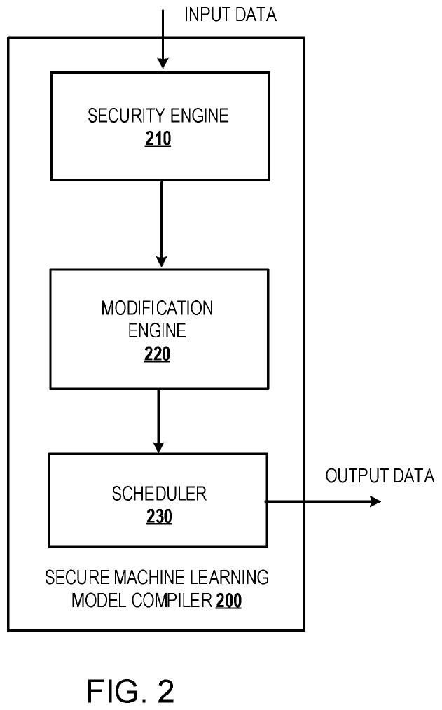

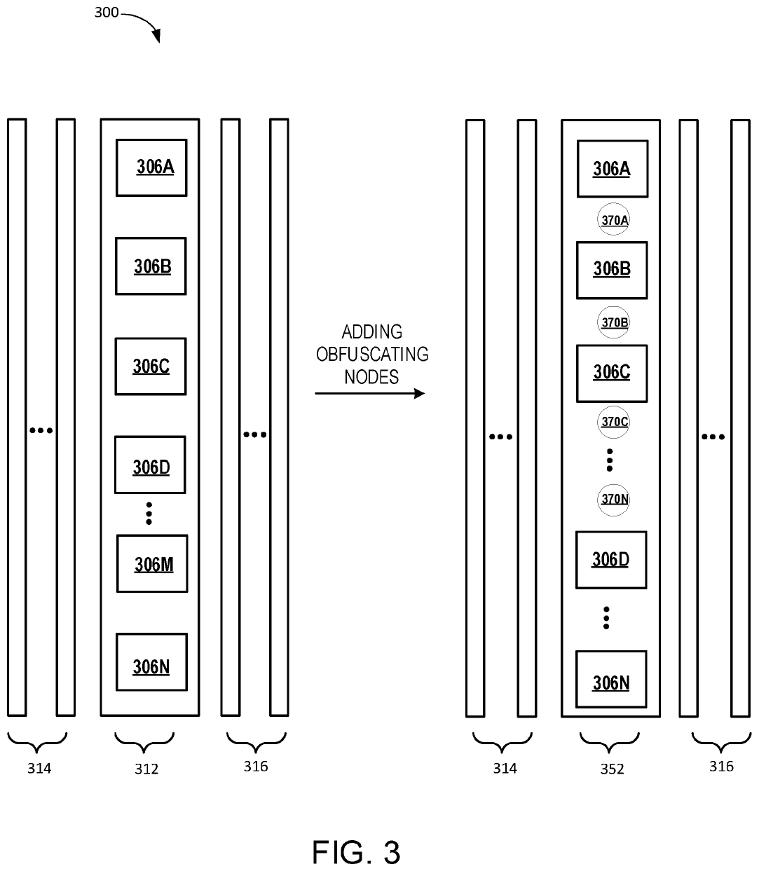

In some implementations, the secure machine learning model compiler 105 is configured to determine whether to compile a machine learning model in a standard mode (in which obfuscating operations are not added) or a secured mode (in which obfuscating operations are added) based on the characteristics of the machine learning model. In general, if the secure machine learning model compiler 105 determines to compile the machine learning model in a standard mode, the secure machine learning model compiler 105 does not include obfuscating operations in the instructions. On the other hand, if the secure machine learning model compiler 105 determines to compile the machine learning model in a secured mode, the secure machine learning model compiler 105 determines one or more obfuscating network structures associated with one or more particular network structures of the machine learning model (e.g., one or more critical layers of a neural network), and generates instructions scheduling computation components on the hardware device 102 to perform respective inference operations specified by the original machine learning model and obfuscating operations specified by the obfuscating network structures. Components and operations of the secure machine learning model compiler 105 are described in greater detail in connection with FIG. 2, and the details of determining obfuscating network structures are described in connection with FIGS. 3-5.

To determine whether to compile a machine learning model using a secured mode, the secure machine learning model compiler 105 can analyze the nature or characteristics of the machine learning model. For example, the secure machine learning model compiler 105 can determine to perform operations under the secured mode if a machine learning model is a giant deep neural network that requires considerable time and cost (e.g., computation cost) to train and the hardware device 102 is located inside an edge device. In this example, the secure machine learning model compiler 105 can select the secure mode based on the size (e.g., by comparing the size of the model to a threshold) and/or based on training time (e.g., by comparing the time taken to train the model to a threshold, and such information can be included in, e.g., metadata transmitted to the secure machine learning model compiler 105). As another example, the secure machine learning model compiler 105 can determine to perform operations of a machine learning model under the secured mode if the machine learning model is used for security-sensitive applications, for example, face unlocking, voice unlocking, signature verification, personal information access or predictions using machine learning models, or other security-sensitive applications. In this example, the metadata associated with machine learning models can include a label or metadata that indicates whether the machine learning model is sensitive or which mode (e.g., secured or regular) that is to be used to perform the operations of the machine learning model. Thus, the secure machine learning model compiler 105 can determine whether to compile a machine learning model under the secured mode or the standard mode based on the metadata.

The hardware device 102 can be a hardware processor, e.g., a hardware accelerator such as a graphics processing unit (GPU), a vision processing unit (VPU), a tensor processing unit (TPU), or other appropriate hardware accelerator. To accelerate performing inference operations, the hardware device 102 includes one or more processing elements 104A-N, and each processing element 104A-N includes one or more computation units 106A-N, which are also referred to as computation units 106 for brevity. The computation units 106 are each a self-contained unit for performing assigned inference operations (e.g., linear or nonlinear operations for a node in a network layer or across network layers). The number of processing elements 104A-N and corresponding computation units for each processing element can vary based on different computation requirements. For example, the hardware device 102 can include 4, 8, 16 or more processing elements each having 4, 8, 16, or more computation units. In addition, different hardware devices 102 can have different arrangements and interconnections for processing elements 104A-N.

After receiving the instructions and/or data from the host 108, the hardware device 102 can store instructions received from the host 108. The instructions can include data representing parameters of the assigned inference operations in a neural network in memory 110 (the details of memory 110 are described below). The parameters of the neural network can include a number of nodes and a number of network layers assigned to the hardware device 102, nodal weights, and corresponding input activations from a previous network layer. If the neural network is compiled under the secured mode, the instructions can further include parameters specifying obfuscating network structures, obfuscating operations associated with the obfuscating network structures, and how the obfuscating network structures are associated with the neural network, input data for performing the obfuscating operations, memory locations for storing computation results from performing the obfuscating operations, or other parameters. For example, computation results from the inference operations and/or from the obfuscating operations specified by the obfuscating network structures can be stored in memory 110, and the results from obfuscating operations are not used for downstream operations.

In some implementations, the hardware device 102 can include a data bus configured to, according to a sequence, communicatively couple the multiple computation units of a processing element. The data bus can include different types of data buses for communicating respective instructions indicating different operations performed on different computation units (e.g., 106A-N in processing element 104A), input data used for performing operations on different computation units, and results for the input data generated on different computation units. For example, the data bus can include a ring bus that starts from a controller (not shown) in the hardware device 102, and provides communications coupling through a bus data path that connects computation units 106-106N sequentially in a ring back to the controller. In some implementations, the data bus can include a mesh bus that provides a communications path that couples or connects each computation unit to its corresponding neighbor computation units in both horizontal and vertical dimensions. The mesh bus can be used to transport input activation quantities between one or more memory units in adjacent computation units.

In general, the received instructions on the hardware device 102 are broadcast to corresponding processing elements 104A-N for processing respective operations. The instructions generally specify a first portion of computation units to perform inference operations and a second portion of computation units to perform obfuscating operations. The instructions can further specify memory units for storing results. For example, the instructions can indicate the results generated by the second portion of computations units for performing obfuscating operations are discarded or saved in memory units (e.g., memory units in the computation units 106) and not accessed for further computations. The obfuscating operations can be performed concurrently or sequentially with the inference operations.

In some implementations, the instructions issued from the host 108 can specify a processing element or a computation unit of a processing element that is added to the hardware device 102 or to the edge device that includes the hardware device 102 for dedicatedly performing the obfuscating operations. The term “dedicatedly” generally refers to one or more processing elements or computation units that are additionally incorporated into a hardware device (e.g., in addition to other elements or units in a hardware device for performing inference operations) and are configured to perform substantially only obfuscating operations and do not perform inference operations associated with deployed machine learning models. The processing elements or computation units dedicatedly for performing obfuscating operations can include, e.g., a processor, a multiplication unit, a multiplexer, a vector reduction unit, a logic gate, or other suitable processing elements or computation units.

The measurable characteristics include an electromagnetic profile for one or more inference operations, a time profile for performing the one or more inference operations, or power consumption profile for computation units performing the inference operations. In some implementations, the measurable characteristics can further include a sound profile and/or a temperature profile for performing the one or more inference operations. An electromagnetic profile can, for example, represent a measure of electromagnetic radiation over a capacitor charge on a hardware device when the hardware device is performing operations of a machine learning model. In some implementations, a characteristic profile can be represented by a graph having a horizontal axis representing time and a vertical axis representing a particular characteristic (e.g., the electromagnetic radiation, the power consumption, the sound, or the temperature).

The obfuscating network structures associated with a neural network can generally include obfuscating nodes in a critical network layer, one or more obfuscating network layers immediately after or before a critical network layer, or one or more concurrent obfuscating network layers that are concurrently performed with a critical network layer. The term “obfuscating network layer immediately before a critical layer” generally refers to situations where the output from the obfuscating network layer is received as input by the critical layer, and the term “obfuscating network layer immediately after a critical layer” generally refers to situations where the input to the obfuscating layer is the output from the critical layer. Obfuscating operations associated with obfuscating nodes and concurrent obfuscating networks are scheduled by the secure machine learning model compiler 105 to be performed concurrently with inference operations of an associated critical network layer, and obfuscating operations associated with one or more obfuscating network layers immediately before or after a critical network layer are scheduled to be performed sequentially with inference operations specified by the critical network layer. For example, the obfuscating operations of an obfuscating layer preceding a critical layer are performed before the critical layer as if the critical layer receives outputs from the preceding obfuscating layer. Similarly, the obfuscating operations of an obfuscating layer succeeding a critical layer are performed after the critical layer as if the critical layer's output is received as input by the succeeding obfuscating layer.

In some implementations, the obfuscating operations can mimic the corresponding inference operations. As an example, inference operations by nodes in a critical layer and obfuscating operations specified by obfuscating nodes in the critical layer can be related to activation functions and are performed concurrently. As another example, obfuscating operations of obfuscating layers before and/or after critical layers can be similar to those specified by the critical layers. Thus, the combined data profiles (e.g., power consumption profile) are different from that for performing only the inference operation, and the measurable characteristics deviates from the true measurable characteristics of the neural network. Accordingly, any reverse-engineered neural network parameters would be different from the true neural network parameters. For example, the reversed-engineered neural network might include obfuscating nodes and obfuscating network layers that are not included in the original neural network.

In some implementations, the obfuscating operations can be irrelevant to (e.g., independent of) the corresponding inference operations, but performing the obfuscating operations can render any measurable data from the hardware device 102 meaningless. For example, when the inference operations are related to matrix reductions, the obfuscating operations can be particular logic operations or scalar additions or multiplications such that the true measurable profiles are altered to lose patterns or features, which become meaningless for determining the true parameters of a neural network. As another example, the obfuscating network structures can include concurrent obfuscating layers that include obfuscating operations to be concurrently performed with inference operations specified by one or more critical layers so that the measurable data from the hardware device 102 are rendered meaningless.

The computation results of inference operations are stored in memory 110, and are provided to the host 108 for other inference operations that depend on the computation results. The computation results for obfuscating operations, however, are not used by any of the inference operations. In some implementations, obfuscating results are discarded without writing to any memory. Alternatively, obfuscating results are written to a memory unit that other computation components for inference operations do not receive any data stored in the memory unit. In another example, the obfuscating results are written to the same memory as inference operations, but are not accessed by inference operations.

FIG. 2 illustrates an example secure machine learning model compiler 200. The secure machine learning model compiler can be equivalent to, or used to implement, the secure machine learning model compiler 105 of FIG. 1.

As shown in FIG. 2, the secure machine learning model compiler 105 is configured to process input data and generate output data by processing the input data. As described above, the input data can include one or more machine learning models (e.g., neural networks) encoded in high-level programming languages. The output data can include compiled machine learning models encoded in a machine-readable low level programming language (e.g., binary code).

The secure machine learning model compiler 200 can include a security engine 210 configured to determine whether to compile a machine learning model in the input data under a secured mode or a standard mode, e.g., based on characteristics of the machine learning model. The characteristics of the machine learning model can represent the time and cost for training the machine learning model. The time and cost for training a machine learning model can be generally related to a size of the machine learning model, a complexity for designing the structures of the machine learning model, a size of training examples for training the machine learning model, an accuracy level set for training the machine learning model, how the machine learning is trained (separately or end-to-end training with additional machine learning models), or other factors. For machine learning models requiring a high cost, the security engine 210 can determine to compile the machine learning models under the secured model. Otherwise, the machine learning models are compiled by the secure machine learning model compiler 200 under the standard mode.

Alternatively or in addition, the characteristics of the machine learning model can represent whether the machine learning model is security-sensitive. For example, a machine learning model trained for face unlocking is security-sensitive, as described above. For machine learning models that are security-sensitive, the security engine 210 can determine to compile these machine learning models under the secured mode. Otherwise, the machine learning models are compiled by the secure machine learning model compiler 200 under the standard mode.

The machine learning model characteristics can be provided to the security engine 210 for analysis in different ways. For example, the machine learning model characteristics can be stored in metadata associated with the machine learning model included in the input data.

In some implementations, the secure machine learning model compiler 200 can receive instructions regarding whether to compile a machine learning model in a secured mode. The instructions can be included in instruction data stored in memory, incorporated in or associated with the program representing the machine learning model, or provided by a user through a user interface. For example, the instructions can include a flag value embedded in the program representing a machine learning model. The flag value can be interchangeably set by a user and cause the secure machine learning model compiler 200 to compile a corresponding machine learning model in a standard mode or a secured mode. The flag value can be a binary value, a logic value, a string, a real number, or any other suitable values. For example, the flag value of “0” can cause the compiler 200 to compile a machine learning model in a standard mode, and the flag value of “1” can cause the compiler 200 to compile in a secured mode. The secure machine learning model compiler 200 further includes a modification engine 220 to determine obfuscating structures to be associated with a machine learning model. For machine learning models that the security engine 210 determines to compile under the standard mode, the secure machine learning model compiler 200 (or the modification engine 220) does not determine obfuscating network structures, and the machine learning models are compiled as is. For a machine learning model that the security engine 210 determines to compile under the secured mode, the modification engine 220 determines one or more critical structures of the machine learning model (e.g., critical layers of a neural network), and corresponding obfuscating structures associated with the one or more critical structures.

For example, if a machine learning model is a neural network, the modification engine 220 determines a critical layer in a sequence of network layers included in the neural network, and determines different obfuscating network structures associated with the critical layer. The obfuscating network structures specify multiple obfuscating operations to alter observed characteristics of the neural network, which eventually protects the neural network parameters from being deciphered by unauthorized third parties. For simplicity, the specification below uses “neural network” as an example machine learning model for illustration. It should be noted a machine learning model can include any other suitable models other than a neural network, and the described techniques can be suitably applied to different machine learning models.

The modification engine 220 can use various techniques to determine a critical layer in a neural network. For example, the modification engine 220 can determine whether a layer is a critical layer based on one or more criteria. The criteria can include, for example, (i) whether a layer in a neural network includes one or more nodal weights that have been updated over a threshold value during training, (ii) whether the number of nodal weights updated in the network layer is above a threshold number, (iii) whether the number of nodal weights in the network layer that have been dropped out or determined as zero is above a threshold number, or other suitable criteria. In response to determining that a layer satisfies one or more of the above-noted criteria, the modification engine 220 can determine such a layer to be a critical layer. As a naive example, a trained machine learning model can be a pre-training neural network after fine-tuning, the modification engine 220 can determine layers with most nodal weight changes or layers with nodal weight changes satisfying a threshold value to be critical layers. As another example, the modification engine 200 can determine whether a layer is a critical layer based on input data and/or output data of the layer. The modification engine 200 can compare one or more properties of the input and/or output data (e.g., data type, data size, or other properties) with respective threshold values or a predetermined set of properties. In some situations, the modification engine 200 can further compare a level of data read/write associated with input/output data for a network layer against a threshold value. For example, the modification engine 200 can determine a layer to be a critical layer if the level of data read/write associated with the layer satisfies a threshold.

After determining a critical layer, the modification engine 220 can determine one or more obfuscating network structures for the critical layer. The modification engine 220 can determine the obfuscating network structures based on different obfuscating tasks. For example, the obfuscating network structures can include obfuscating nodes with obfuscating nodal operations to be added to a critical layer. As another example, the obfuscating network structures can include obfuscating network layers immediately before and/or after a critical layer. Alternatively or in addition, the obfuscating network structures can include one or more concurrent obfuscating network layers specifying obfuscating operations that are scheduled to be concurrently performed with inference operations of the critical layer. The details of generating obfuscating network structures are described in connection with FIGS. 3-5.

The scheduler 230 is configured to schedule the performance of both the inference operations and obfuscating operations at computation units of a hardware device. For example, scheduler 230 can assign one or more inference operations to a first set of computation units of a hardware device, and assign one or more obfuscating operations to a second portion of computation units of the hardware device. The scheduler 230 can further determine when to perform the obfuscating operations and inference operations. For example, the scheduler 230 can assign portions of computation units to perform inference operations and obfuscating operations concurrently or sequentially. For situations where the hardware device includes computation units and/or processing elements dedicatedly for performing obfuscating operations, the scheduler 230 can assign the obfuscating operations to the dedicated computation units and/or processing elements. In this way, the hardware device can maximize the utilization of processing elements for inference operations.

FIG. 3 illustrates an example process 300 of obfuscating network structures associated with an input neural network. The obfuscating network structures can be determined by a secure machine learning model compiler when the compiler compiles an input neural network. The secure machine learning model compiler can be equivalent to the secure machine learning model compiler 105 of FIG. 1 and/or the secure machine learning model compiler 200 of FIG. 2.

As shown in FIG. 3, the secure machine learning model compiler included in the described system can determine a critical layer of an input neural network. The neural network can include multiple network layers arranged according to a sequence (e.g., network layers 312, 314, 316). The secure machine learning model compiler can determine whether to compile the neural network under a secured mode, and responsive to determining to compile the neural network under the secured mode, the secure machine learning model compiler can determine a critical layer from the sequence of network layers.

As described above, the secure machine learning model compiler can determine the critical layer based on one or more criteria, for example, comparing the number of weights changed for a layer against a threshold number, or comparing a measure of value change in nodal weights for a layer against a threshold value. If the network layer satisfies one or more criteria, the secure machine learning model compiler determines the network layer as a critical layer. For example and as shown in FIG. 3, the secure machine learning model compiler can determine a critical layer 312 in the input neural network. The neural network further includes one or more preceding network layers 314 that precede the critical layer in the sequence, and one or more succeeding network layers 316 that succeed the critical layer in the sequence. The critical layer 312 can include one or more nodes 306A-N, each having a nodal weight value and a corresponding nodal operation (e.g., nodal activation functions as described above).

The obfuscating network structures in the example process 300 include one or more obfuscating nodes 370A-N to be associated with (e.g., adding obfuscating nodes) critical layer 312. The modified critical layer 352 represents both the original inference operations and obfuscation operations specified by the added obfuscating nodes 370A-N.

The secure machine learning model compiler, when compiling the original neural network, can incorporate the one or more obfuscating nodes 370A-N into the critical layer in various ways. For example, the secure machine learning model compiler can add an obfuscating node 370A between two neighboring nodes (e.g., 306A and 306B). Alternatively or in addition, the secure machine learning model compiler can add two or more obfuscating nodes (e.g., 370C, 370D, 370E, and 370F) between two neighboring nodes (e.g., 306C and 306D). Each obfuscating node 370A, 370B, . . . or 370N represents an obfuscating nodal weight and an obfuscating nodal operation, and further specifies a corresponding obfuscating operation. For example, an obfuscating node can include an obfuscating nodal weight with a predetermined value, e.g., zero, one, or other values. The obfuscating nodal weight can be, for example, similar to one of the two neighboring original nodes. The nodal operation of an obfuscating node 370A-N can include any suitable nodal operations, e.g., Tanh, Sigmoid, or other nodal operations, as described above. An obfuscating nodal operation can be, for example, similar to one of the two neighboring nodes.

The obfuscating operations can include operations over values associated with these obfuscating nodes 370A-N. For example, an obfuscating operation can include a suitable operation (e.g., the matrix multiplication, tensor reduction, pooling, or other suitable operation) over one or more obfuscating nodal weights, one or more obfuscating nodal operations, or both. As described above, the input values for obfuscating operations can be predetermined and stored in one or more memory units in the hardware device. The output values by performing obfuscating operations are generally not used for downstream inference operations. Rather, these output values are discarded or stored in one or more memory addresses that are not accessed for inference operations.

Furthermore, the obfuscating operations are specified by the obfuscating nodes 370A-N in a critical layer, and thus these obfuscating operations are scheduled by the secure machine learning model compiler and transmitted in a data form of instructions to the hardware device to be performed concurrently with inference operations specifies by original nodes and the critical layer.

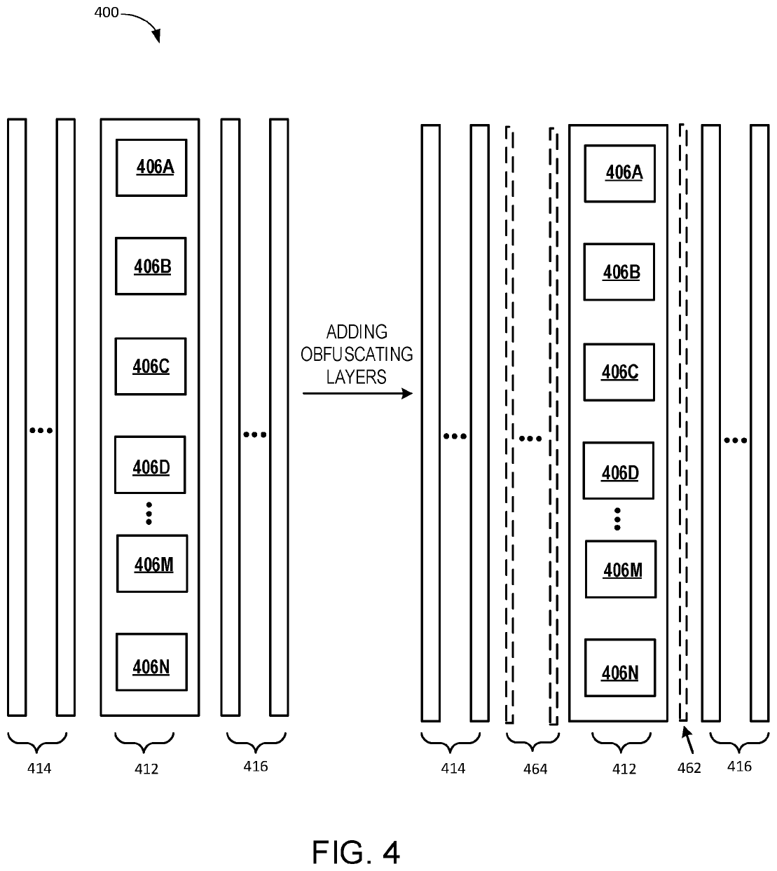

FIG. 4 illustrates another example process 400 of obfuscating network structures associated with an input neural network. The obfuscating network structures can be determined by a secure machine learning model compiler when it compiles an input neural network. The secure machine learning model compiler can be equivalent to the secure machine learning model compiler 105 of FIG. 1 and/or the secure machine learning model compiler 200 of FIG. 2.

Similarly, the secure machine learning model compiler included in the described system can determine a critical layer 412 of an input neural network for compiling from a sequence of network layers (414, 412, and 416), as shown in FIG. 4. The one or more network layers 414 are preceding neural network layers that precede the critical layer 412 in the sequence, and the one or more network layers 416 are succeeding network layers 316 that succeed the critical layer 412 in the sequence. The critical layer 412 can include one or more nodes 406A-N, each having a nodal weight value and a corresponding nodal operation (e.g., nodal activation functions as described above).

The obfuscating network structures of the example process 400 include one or more obfuscating network layers 464 and/or 462. The secure machine learning model compiler is configured to modify the input neural network by adding the one or more obfuscating network layers 464 and/or 462 before and/or after the critical layer 412 according to a sequence. For example, the one or more obfuscating network layers 464 are added before the critical layer 412 and after the preceding network layers 414. Alternatively or in addition, another obfuscating network layer 462 is further added immediately after the critical layer 412 and before the succeeding network layers 416. Note that the obfuscating layers can include any suitable number of obfuscating layers before and/or after the critical layer 412, e.g., one, two, three, five, ten, or other suitable numbers.

Each obfuscating network layer can include one or more obfuscating nodes. Each obfuscating node in an obfuscating network layer can include an obfuscating nodal weight value and an obfuscating nodal operation. Each obfuscating network layer can include one or more obfuscating operations associated with the obfuscating layer. For example, the obfuscating operations can include one or more inter-layer matrix operations (e.g., layer outputs generated from a previous layer multiply obfuscating nodal weights of the obfuscating layer). As another example, the obfuscating operations can include one or more pooling operations of layer outputs of a previous layer. In some implementations, the layer and nodal operations in an obfuscating layer can be similar to those specified by a critical layer. Alternatively, the obfuscating operations specified by an obfuscating layer can be a different type from those in a critical layer. For example, the obfuscation operations can include matrix multiplications but the critical layers include pooling or softmax operations, or vice versa.

As described above, the input values for obfuscating operations specified by an obfuscating layer can be predetermined and stored in one or more memory units in the hardware device. The output values by performing obfuscating operations specified by an obfuscating layer are generally not used for downstream inference operations. Rather, these output values are discarded or stored in one or more memory addresses that are not accessed for inference operations.

Furthermore, the obfuscating operations specified by an obfuscating layer are scheduled by the secure machine learning model compiler to be performed according to the sequence of network layers in the modified neural network. Even though outputs of an obfuscating network layer are generally not used for inference operations specified by a succeeding network layer (e.g., a critical layer), the inference operations specified by original network layers and the obfuscating operations specified by the obfuscating layers are still performed sequentially according to the layer sequence, as if an original network layer succeeding an obfuscating layer receives outputs from the obfuscating layer. Accordingly, it makes unauthorized third parties more difficult to determine which layer is an obfuscating layer or a real layer in the input neural network, based on the above-described data profiles observed from hardware devices.

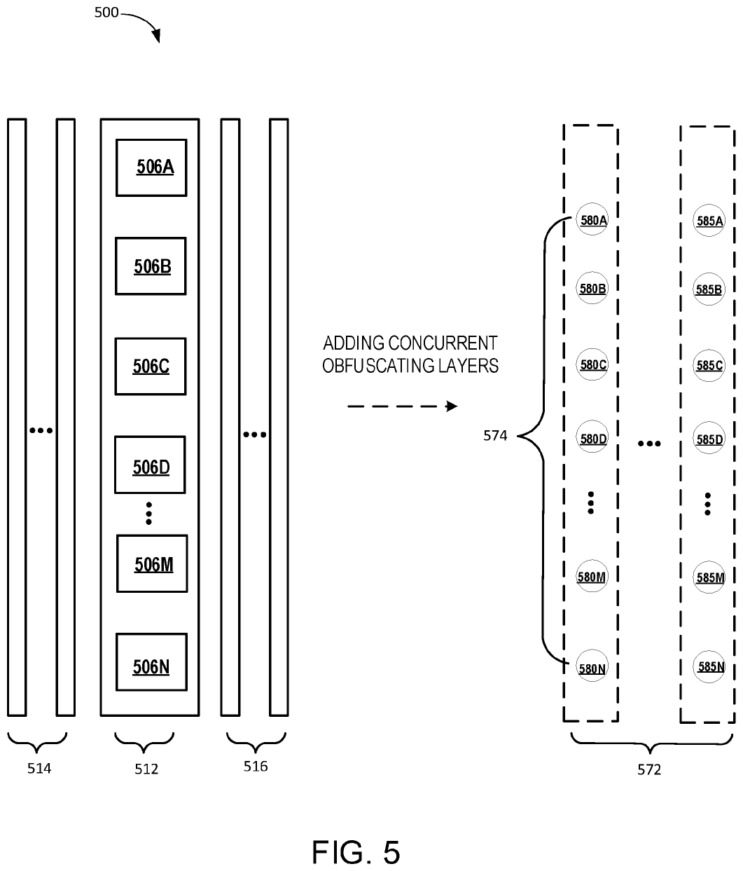

FIG. 5 illustrates another example process 500 of obfuscating network structures associated with an input neural network. The obfuscating network structures can be determined by a secure machine learning model compiler when it compiles an input neural network. The secure machine learning model compiler can be equivalent to the secure machine learning model compiler 105 of FIG. 1 and/or the secure machine learning model compiler 200 of FIG. 2.

Similar to the above-described in connection with FIG. 4, the obfuscating network structures of the example process 500 also include obfuscating network layers associated with a critical layer. However, the secure machine learning model compiler does not alter the structure (or parameters) of an input neural network using the obfuscating network layers. Instead, the secure machine learning model compiler determines one or more obfuscating layers specifying obfuscating operations to be performed concurrently with inference operations specified by the critical layer. These obfuscating layers are also referred to as concurrent obfuscating layers in the following description.

More specifically, the secure machine learning model compiler, when compiling the input neural network, determines one or more concurrent obfuscating layers 572 to be associated with a critical layer 512 in a sequence of network layers 512, 514, and 516 of the input neural network.

The one or more concurrent obfuscating network layers 572 each have one or more obfuscating nodes 574. For example, a first concurrent obfuscating network layer can include multiple obfuscating nodes 580A-N, and a second concurrent obfuscating network layer can include multiple obfuscating nodes 585A-N. As described above, each obfuscating node in an obfuscating network layer can include an obfuscating nodal weight value and an obfuscating nodal operation. Each concurrent obfuscating network layer can include one or more obfuscating operations associated with the concurrent obfuscating layer. For example, the obfuscating operations can include one or more inter-layer matrix operations (e.g., layer outputs generated from a previous layer multiply obfuscating nodal weights of the obfuscating layer). As another example, the obfuscating operations can include one or more pooling operations of layer outputs of a previous layer. In some implementations, the layer and nodal operations in a concurrent obfuscating layer can be similar to those specified by a critical layer. Alternatively, the obfuscating operations specified by a concurrent obfuscating layer can be a different type from those in a critical layer. For example, the obfuscation operations can include pooling and/or softmax operations but the critical layers include matrix multiplications, or vice versa.

As described above, the input values for obfuscating operations specified by a concurrent obfuscating layer can be predetermined and stored in one or more memory units in the hardware device. The output values by performing obfuscating operations specified by a concurrent obfuscating layer are generally not used for downstream inference operations. Rather, these output values are discarded or stored in one or more memory addresses that are not accessed for inference operations.

Furthermore, the obfuscating operations specified by a concurrent obfuscating layer are scheduled by the secure machine learning model compiler to be performed concurrently with inference operations specified by corresponding critical network layers. In this way, the observed profiles of one or more characteristics for a neural network could be altered, which further prevents or at least increases the time and cost for deciphering one or more parameters of the neural network (e.g., parameters specifying one or more critical layers of the neural network).

Although only one critical layer is shown in FIGS. 3-5 for simplicity of illustration, it should be noted that the secure machine learning model compiler is configured to determine more than one critical layer in a neural network. In addition, although only one type of obfuscating network structures are illustrated for each figure of FIGS. 3-4, it should be appreciated that any one or more of the obfuscating network structures can be combined in various ways for a critical network layer.

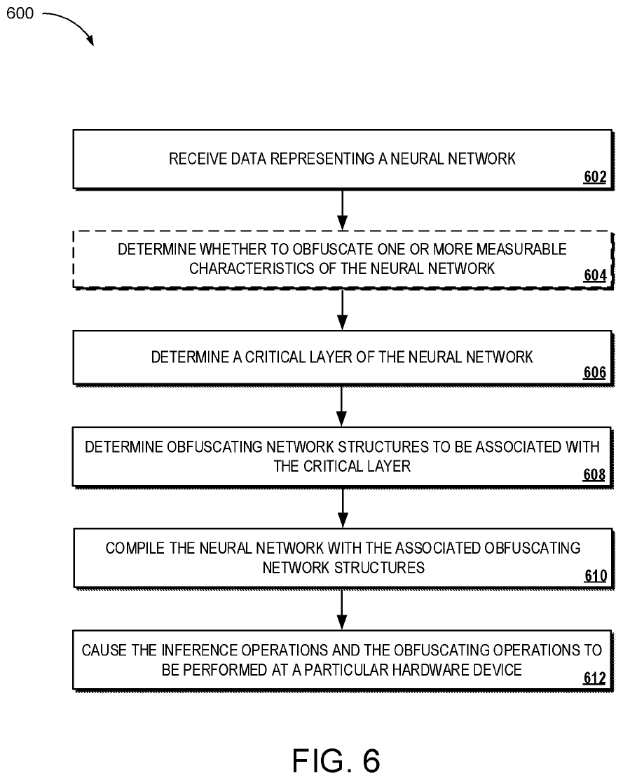

FIG. 6 is an example flow chart of the process 600 for compiling an input neural network with obfuscating network structures. For convenience, the process 600 is described as being performed by a system of one or more computers located in one or more locations. For example, the process 600 can be performed on a host or by a compiler located in the host, e.g., the secure machine learning model compiler 105 shown in FIG. 1 or the secure machine learning model compiler 200 shown in FIG. 2. The order of steps in the process 600 is illustrative only, and can be performed in different orders. In some implementations, the process 600 can include additional steps, fewer steps, or some of the steps can be divided into multiple steps.

The system receives data representing a machine learning model (610). The machine learning model can include various types of machine learning models, for example, a neural network. Data representing a neural network can specify multiple inference operations. The neural network can include parameters specifying a sequence of multiple network layers, multiple nodes in each of the multiple layers, nodal weights and nodal operations for each node, and other structures associated with the neural network. In some implementations, the data can further include metadata indicating additional information related to the machine learning model. For example, the metadata can indicate whether a machine learning model is security-sensitive, and/or a time and/or cost for training the machine learning model. For simplicity, the description below is based on a neural network received by the system.

The system generally compiles the neural network to generate instructions that, when executed, causes one or more computation units of a hardware device to perform inference operations of the neural network, and in some situations, to also perform obfuscating operations associated with the neural network.

The obfuscating operations, when performed, could obfuscate one or more measurable characteristics of the neural network. More specifically, the obfuscating operations can change at least one or more measurable characteristics of the neural network. For example, the obfuscating operations, when performed, are configured to obscure at least one of a number of network layers of the neural network, a number of nodes in a network layer of the neural network, a nodal operation for a node in a network layer of the neural network, or a weight value associated with a node in a network layer of the neural network, as described above.

The measurable characteristics can include at least one of a power profile, an electromagnetic profile, or a time profile. Once the measurable characteristics are changed, it would become more difficult to determine the parameters of the neural network based on the measurable characteristics. The obfuscating operations can include operations that are similar to the inference operations, e.g., activation operations, tensor multiplications, and reductions. For example, the obfuscating operations can include an obfuscating nodal operation specified by an obfuscating node in a network layer performed concurrently with other nodal operations in the network layer. The obfuscating nodal operation can be a nodal addition or nodal multiplication. Alternatively, the obfuscating nodal operation of an obfuscating node can specify an activation function for the particular node, different from an actual activation function of an actual node in the same network layer performed concurrently with the obfuscating nodal operation. In some implementations, the obfuscating operations can include operations irrelevant to and/or different from inference operations. The obfuscating operations can be performed concurrently with corresponding inference operations or sequentially according to an order. More details related to the obfuscating operations are described above.

To compile the neural network, the system determines whether to obfuscate one or more measurable characteristics of the neural network (620). As described above, the system determines whether to obfuscate one or more measurable characters of the neural network based on characteristics or nature of the neural network. Based on input data associated with the neural network, the system determines whether the neural network is security-sensitive, and/or has required a considerable amount of time and/or cost for training that satisfies a particular threshold. In response to determining that the neural network is security-sensitive, and/or has required a considerable amount of resources, the system determines to compile the neural network under a “secured mode,” as described above. In the “secured mode,” the system could obfuscate one or more measurable characteristics of the neural network by determining one or more obfuscating operations to be included in instructions in addition to inference operations specified by the neural network when compiling the neural network, and the one or more obfuscating operations, when performed with inference operations, could obfuscate one or more measurable characteristics of the neural network. In some implementations, the step 620 is optional. For example, the system or the host can, without the need to determine, receive user instructions or input data instructing the host to compile an input neural network under the “secured mode.”

The system determines a critical layer of the sequence of network layers (630). The critical layer is determined based on the characteristics of the neural network. For example, the system can determine the critical layer based on the layer type (e.g., a pooling layer, a fully-connected layer, a softmax layer). As another example, the system can determine the critical layer based on updates on parameters of network layers during training. More specifically, the system can compare parameters updates (e.g., the number of updates for nodes in a network layer, the value changes in nodes in a network layer, the number of dropped-out nodes in a network layer, or a change in inter-layer connectivity between a network layer and neighboring layers) against one or more criteria (e.g., threshold numbers or values). Alternatively, the system can receive metadata associated with the neural network that indicates one or more critical layers. The descriptions regarding determining a critical layer are described in detail above.

The system determines obfuscating network structures to be associated with the critical layer (640). As described above, the system determines various obfuscating network structures to be associated with the critical layer. For example, the obfuscating network structures can include obfuscating nodes specifying respective obfuscating nodal weights and obfuscating nodal operations. The system can modify the neural network by adding one or more obfuscating nodes in a critical layer. Obfuscating operations specified by the obfuscating nodes added to a critical layer are generally performed concurrently with inference operations specified by the original nodes in the critical layer. As another example, the obfuscating network structures can include one or more obfuscating network layers. The system can modify the neural network by inserting the one o or more obfuscating network layers (immediately) before and/or after a critical layer in the sequence of network layers. Each obfuscating network layer includes multiple obfuscating nodes similar to those described above. Obfuscating operations specified by obfuscating network layers are generally performed according to an order. For example, the order is determined based on the sequence of modified network layers in the modified network. Alternatively or in addition, the obfuscating network structures include one or more concurrent obfuscating network layers. Different from the obfuscating network layers inserted in the original sequence of network layers of a neural network, the system does not modify the neural network using the concurrent obfuscating layers. Instead, the system keeps the neural network structure unchanged, and generates instructions for hardware devices to perform obfuscating operations of the concurrent obfuscating layers concurrently with one or more corresponding critical network layers.

The system compiles the neural network with the associated obfuscating network structures (650). During compiling, the system generates instructions for performing the obfuscating operations specified by the obfuscating network structures and the inference operations specified by the compiled neural network. In some implementations, the obfuscating operations are scheduled to be performed concurrently with inference operations, e.g., obfuscating operations specified by obfuscating network structures such as obfuscating nodes and concurrent obfuscating network layers. Alternatively or in addition, the obfuscating operations and inference operations are scheduled to be performed sequentially according to an order, e.g., obfuscating operations specified by obfuscating network structures such as obfuscating network layers.

In some implementations, the system further determines a schedule in the instructions for one or more corresponding hardware devices. The schedule generally specifies a sequence for the hardware devices to perform the obfuscating operations specified by corresponding obfuscating network structures and the inference operations specified by the neural network. For each hardware device of the one or more hardware devices, the schedule further indicates different portions of a set of computation units of the hardware device to perform respective inference and/or obfuscating operations.

In some implementations, the system can transmit data including the above-described instructions to one or more hardware devices. An example hardware device can be an edge device such as a smartphone, a smart watch, a smart tablet, or a laptop, just to name a few examples. In some implementations, the system can further generate data to trigger the instructions to be performed by the one or more hardware devices, which causes the inference operations specified by the neural network and the obfuscating operations specified by the obfuscating network structures to be performed at corresponding hardware devices (660).

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

In addition to the embodiments described above, the following embodiments are also innovative:

Embodiment 1 is a method, comprising: receiving data representing a neural network including inference operations, wherein the neural network comprises parameters specifying a sequence of network layers and multiple nodes in each layer of the sequence of network layers; compiling the neural network to generate instructions that, when executed, causes one or more computation units of a hardware device to perform obfuscating operations associated with the neural network and the inference operations of the neural network, wherein the obfuscating operations, when performed, obfuscate one or more measurable characteristics of the neural network, the compiling comprising: determining a critical layer of the sequence of network layers; determining obfuscating network structures for association with the critical layer; and compiling the neural network with the associated obfuscating network structures to generate instructions for performing the obfuscating operations specified by the obfuscating network structures; and causing the inference operations and the obfuscating operations to be performed at a hardware device.

Embodiment 2 is the method of Embodiment 1, wherein the compiling further comprises: determining to obfuscate the one or more measurable characteristics of the neural network.

Embodiment 3 is the method of Embodiment 1 or 2, wherein causing the inference operations and the obfuscating operations to be performed at the hardware device comprises causing the hardware device to perform the inference operations and the obfuscating operations concurrently.

Embodiment 4 is the method of any one of Embodiments 1-3, wherein causing the inference operations and the obfuscating operations to be performed at the hardware device comprises causing the hardware device to perform the inference operations and the obfuscating operations sequentially.

Embodiment 5 is the method of any one of Embodiments 1-4, wherein the obfuscating operations are configured to obscure at least one of a number of network layers of the neural network, a number of nodes in a network layer of the neural network, a nodal operation for a node in a network layer of the neural network, or a weight value associated with a node in a network layer of the neural network.

Embodiment 6 is the method of any one of Embodiments 1-5, wherein the one or more measurable characteristics of the neural network comprises at least one of a power profile, an electromagnetic profile, or a time profile.

Embodiment 7 is the method of any one of Embodiments 1-6, wherein determining a critical layer of the sequence of network layers comprises determining the critical layer based on at least one of a type of a network layer, updates on parameters of a network layer, or metadata associated with the network layer.

Embodiment 8 is the method of any one of Embodiments 1-7, wherein determining the obfuscating network structures to be associated with the critical layer comprises adding a obfuscating network layer immediately before and/or after the critical layer in the sequence of network layers.

Embodiment 9 is the method of any one of Embodiments 1-8, wherein determining the obfuscating network structures to be associated with the critical layer comprises determining a obfuscating network layer with obfuscating operations to be concurrently performed with the inference operations of the critical layer.

Embodiment 10 is the method of any one of Embodiments 1-9, wherein determining the obfuscating network structures to be associated with the critical layer comprises adding an obfuscating node to a set of nodes in the critical layer, wherein the obfuscating node comprises obfuscating operations to be concurrently performed with the inference operations of the critical layer.

Embodiment 11 is the method of any one of Embodiments 1-10, wherein the particular hardware device comprises an edge device.

Embodiment 12 is the method of any one of Embodiments 1-11, wherein compiling the neural network to generate instructions comprises: determining a schedule in the instructions for the particular hardware device, wherein the schedule specifies a sequence for performing the obfuscating operations and the inference operations on respective sets of computation units of the particular hardware device.

Embodiment 13 is a system comprising one or more computers and one or more storage devices storing instructions that when executed by one or more computers cause the one or more computers to perform respective operations, the operations comprising the method of any one of Embodiments 1-12.

Embodiment 14 is one or more computer-readable storage media storing instructions that when executed by one or more computers cause the one or more computers to perform respective operations, the respective operations comprising the method of any one of Embodiments 1-12.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A method, comprising:
receiving data representing a neural network including inference operations, wherein the neural network comprises parameters specifying a sequence of network layers and multiple nodes in each layer of the sequence of network layers;
compiling the neural network to generate instructions that, when executed, causes one or more computation units of a hardware device to perform obfuscating operations associated with the neural network and the inference operations of the neural network, wherein the obfuscating operations, when performed, obfuscate one or more measurable characteristics of the neural network, the compiling comprising:
determining a target layer of the sequence of network layers;
determining obfuscating network structures for association with the target layer; and
compiling the neural network with the associated obfuscating network structures to generate instructions for performing the obfuscating operations specified by the obfuscating network structures; and
causing the inference operations and the obfuscating operations to be performed at a hardware device.

2. The method of claim 1, wherein the compiling further comprises:
determining to obfuscate the one or more measurable characteristics of the neural network.

3. The method of claim 1, wherein causing the inference operations and the obfuscating operations to be performed at the hardware device comprises causing the hardware device to perform the inference operations and the obfuscating operations concurrently.

4. The method of claim 1, wherein causing the inference operations and the obfuscating operations to be performed at the hardware device comprises causing the hardware device to perform the inference operations and the obfuscating operations sequentially.

5. The method of claim 1, wherein the obfuscating operations are configured to obscure at least one of a number of network layers of the neural network, a number of nodes in a network layer of the neural network, a nodal operation for a node in a network layer of the neural network, or a weight value associated with a node in a network layer of the neural network.

6. The method of claim 1, wherein the one or more measurable characteristics of the neural network comprise at least one of a power profile, an electromagnetic profile, or a time profile.

7. The method of claim 1, wherein determining a target layer of the sequence of network layers comprises determining the target layer based on at least one of a type of a network layer, updates on parameters of a network layer, or metadata associated with the network layer.

8. The method of claim 1, wherein determining the obfuscating network structures to be associated with the target layer comprises adding an obfuscating network layer immediately before and/or after the target layer in the sequence of network layers.

9. The method of claim 1, wherein determining the obfuscating network structures to be associated with the target layer comprises determining an obfuscating network layer with obfuscating operations to be concurrently performed with the inference operations of the target layer.

10. The method of claim 1, wherein determining the obfuscating network structures to be associated with the target layer comprises adding an obfuscating node to a set of nodes in the target layer, wherein the obfuscating node comprises obfuscating operations to be concurrently performed with the inference operations of the target layer.

11. The method of claim 1, wherein the particular hardware device comprises an edge device.

12. The method of claim 1, wherein compiling the neural network to generate instructions comprises:
determining a schedule in the instructions for the particular hardware device, wherein the schedule specifies a sequence for performing the obfuscating operations and the inference operations on respective sets of computation units of the particular hardware device.

13. A system comprising one or more computers and one or more storage devices storing instructions that when executed by one or more computers cause the one or more computers to perform operations comprising:
receiving data representing a neural network including inference operations, wherein the neural network comprises parameters specifying a sequence of network layers and multiple nodes in each layer of the sequence of network layers;
compiling the neural network to generate instructions that, when executed, causes one or more computation units of a hardware device to perform obfuscating operations associated with the neural network and the inference operations of the neural network, wherein the obfuscating operations, when performed, obfuscate one or more measurable characteristics of the neural network, the compiling comprising:
determining a target layer of the sequence of network layers;
determining obfuscating network structures for association with the target layer; and
compiling the neural network with the associated obfuscating network structures to generate instructions for performing the obfuscating operations specified by the obfuscating network structures; and
causing the inference operations and the obfuscating operations to be performed at a hardware device.

14. (canceled)

15. The system of claim 13, wherein the compiling further comprises: determining to obfuscate the one or more measurable characteristics of the neural network.

16. The system of claim 13, wherein causing the inference operations and the obfuscating operations to be performed at the hardware device comprises causing the hardware device to perform the inference operations and the obfuscating operations concurrently.

17. The system of claim 13, wherein causing the inference operations and the obfuscating operations to be performed at the hardware device comprises causing the hardware device to perform the inference operations and the obfuscating operations sequentially.

18. The system of claim 13, wherein the obfuscating operations are configured to obscure at least one of a number of network layers of the neural network, a number of nodes in a network layer of the neural network, a nodal operation for a node in a network layer of the neural network, or a weight value associated with a node in a network layer of the neural network.

19. The system of claim 13, wherein the one or more measurable characteristics of the neural network comprise at least one of a power profile, an electromagnetic profile, or a time profile.

20. The system of claim 13, wherein determining a target layer of the sequence of network layers comprises determining the target layer based on at least one of a type of a network layer, updates on parameters of a network layer, or metadata associated with the network layer.

21. One or more computer-readable storage media storing instructions that when executed by one or more computers cause the one or more computers to perform operations comprising:
receiving data representing a neural network including inference operations, wherein the neural network comprises parameters specifying a sequence of network layers and multiple nodes in each layer of the sequence of network layers;
compiling the neural network to generate instructions that, when executed, causes one or more computation units of a hardware device to perform obfuscating operations associated with the neural network and the inference operations of the neural network, wherein the obfuscating operations, when performed, obfuscate one or more measurable characteristics of the neural network, the compiling comprising:
determining a target layer of the sequence of network layers;
determining obfuscating network structures for association with the target layer; and
compiling the neural network with the associated obfuscating network structures to generate instructions for performing the obfuscating operations specified by the obfuscating network structures; and
causing the inference operations and the obfuscating operations to be performed at a hardware device.
